(19) United States
(12) Patent Application Publication
(10) Pub. No.: US 2009/0153881 A1
(43) Pub. Date: Jun. 18, 2009

(54) METHOD AND APPARATUS FOR MEASURING 3-DIMENSIONAL POSITION AND ORIENTATION OF REFLECTIVE MIRROR PACKAGE

(75) Inventors: Yong-chul CHO, Suwon-si (KR); Seok-mo CHANG, Bucheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRO-MECHANICS CO., LTD., Suwon-si (KR)

(21) Appl. No.: 12/137,673

(22) Filed: Jun. 12, 2008

(30) Foreign Application Priority Data
Dec. 12, 2007 (KR) 10-2007-0129107

(51) Int. Cl. G01B 11/00

(52) U.S. Cl. 356/614

(57) ABSTRACT

Provided are a method and an apparatus for measuring a 3-dimensional (3D) position and an orientation of an object. The apparatus includes: a height measurement unit including a first light source and a first image sensor receiving light that is emitted from the first light source to the object and reflected from the object; a position measurement unit including a second light source, and a second image sensor receiving light that is emitted from the second light source to the object and reflected from the object; a tilt angle measurement unit including a third light source and a third image sensor receiving light that is emitted from the third light source to the object and reflected from the object; and a controlling unit selectively powering on or off the first, second, and third light sensors, and calculating a height variation, a position variation and tilt angles of the object by using images that are respectively formed on the first, second, and third image sensors.

### CROSS-REFERENCE TO RELATED PATENT APPLICATION

This application claims priority from Korean Patent Application No. 10-2007-0129107, filed on Dec. 12, 2007 in the Korean Intellectual Property Office, the disclosure of which is incorporated herein in its entirety by reference.

### BACKGROUND OF THE INVENTION

1. Field of the Invention

Methods and apparatuses consistent with the present invention relate to measuring a three-dimensional (3D) position and an orientation of an object, and more particularly, to measuring a 3D position and orientation of a reflective mirror package of a scanner device.

2. Description of the Related Art

A scanner device includes a reflective mirror for deflecting a laser beam. The reflective mirror is assembled together with a magnet, a yoke, and a base plate so as to constitute a reflective mirror package. The reflective mirror must be precisely assembled to be perpendicular to the magnet so that the reflective mirror can be correctly driven according to an electrical driving signal, thereby preventing a displayed image from being geometrically distorted or light beams from trembling when the scanner device operates. However, since assembling errors arises due to dimensional errors of diverse elements, such dimensional errors should be precisely measured.

U.S. Pat. No. 5,204,734 discloses a method of measuring the height and the tilt angle of an object by using a single image sensor as the element for measuring dimensional errors, wherein the method is based on the interference of white light.

According to the method, white light reflected from an object generates interference patterns on the image sensor. In order to measure the height of the object, an object lens is vertically scanned, thereby obtaining the height of an optimum focal point. Then, detail information regarding the height of the object can be obtained via the interference patterns that are consecutively arranged. Then, a surface is fitted to a 3-dimensional shape by using data regarding the height, thereby obtaining the tilt angle of the reflective mirror. However, in order to generate the interference patterns, there is a need for a plane having a measurement object surface of which height variation is less than several micrometers. In addition, when the size of the object is 4 mm or more, if a lens having low magnifying power is used, a great height difference is generated due to an initial error generated due to a tilt angle. Thus, it is difficult to form the interference patterns.

In addition, as another device for measuring dimensional errors, an optical measurement system including various unit sensors for measuring a position of an object has been introduced. A method for measuring the two-dimensional (2D) pose (δx, δy, and rotation angle (0)) and height (δZ) of an object by using a single image sensor and a light source has also been disclosed. Tilt angles (α, β) are measured using a separate inclined light source and an image sensor. Likewise, when the signal image sensor is used, the 2D position and the height of the object can be measured using the single image sensor. However, when another object having a size different from that of a previously measured object is measured, it is difficult to calibrate the image sensor. In order to measure the tilt angles (α, β) of the new object, the new object needs to be positioned at a predetermined height. That is, the image sensor measures the height of the object. Then, the height of the object is regulated by moving the scanner device, and then the tilt angles (α, β) of the object are measured. Otherwise, it is difficult to distinguish the tilt angles (α, β) and the height of the object since a height error affects the tilt angles (α, β). In addition, when a base line and the object are on the same plane, the position of the object can be measured. However, when the base line and the object are not on the same plane, since the depth of focus is reduced, it is difficult to simultaneously measure the tilt angle and the height of the object.

Accordingly, there is a need to automatically simultaneously measure a 3D position and an orientation of an object without additionally moving the object after the object is positioned on a predetermined surface. In addition, a sensor for measuring the 3-dimensional position and the orientation of an object should be easily employed to measure objects of different sizes and also account for possible errors of the 3D position and the orientation (the height and the tilt angle) of the object. To achieve this, unit sensors of various types need to operate independently and be decoupled from each other.

### SUMMARY OF THE INVENTION

The present invention provides a method and an apparatus for simultaneously measuring a 3D position and an orientation of an object, which can reduce a measurement time and be easily employed to measure various objects.

According to an aspect of the present invention, there is provided an apparatus for measuring a 3D position and an orientation of an object, the apparatus including: a height measurement unit including a first light source and a first image sensor receiving light that is emitted from the first light source to the object and then is reflected from the object, the height measurement unit obtaining information regarding the height of the object; a position measurement unit including a second light source, and a second image sensor receiving light that is emitted from the second light source to the object and then is reflected from the object, the position measurement unit obtaining information regarding the position of the object; a tilt angle measurement unit including a third light source and a third image sensor receiving light that is emitted from the third light source to the object and then is reflected from the object, the tilt angle measurement unit obtaining information regarding the tilt angle of the object; and a controlling unit selectively powering on or off the first, second, and third light sensors, and calculating a height variation (δZ), a position variation (δX, δY, θ) and tilt angles (α, β) of the object by using images that are respectively formed on the first, second, and third image sensors, wherein optical paths of light in the height measurement unit, the position measurement unit, and the tilt angle measurement unit are along the same optical axis, and the height measurement unit, the position measurement unit, and the tilt angle measurement unit operate independently.

According to another aspect of the present invention, there is provided a method of measuring a 3D position and an orientation of an object using the apparatus, the method including: positioning the object on a stage; calculating a position variation of the object by using information obtained by the position measurement unit; calculating a height variation of the object by using information obtained by the height measurement unit; and calculating tilt angles of the object by using information obtained by the tilt angle measurement unit.

### BRIEF DESCRIPTION OF THE DRAWINGS

The above and other aspects of the present invention will become more apparent by describing in detail exemplary embodiments thereof with reference to the attached drawings in which:

FIG. 1 is a structural view of an apparatus for measuring a 3D position and an orientation of an object according to an exemplary embodiment of the present invention.

FIG. 2 is a flow chart illustrating a method of measuring variables required for measuring a 3-dimensional position and an orientation by using the apparatus of FIG. 1, according to an exemplary embodiment of the present invention;

FIGS. 3 and 4 illustrate a method of converting a height that is actually measured into a value with respect to the center of a reflective mirror, according to an exemplary embodiment of the present invention;

FIG. 5 is a perspective view illustrating a position and an angle of a reflective mirror package, according to an exemplary embodiment of the present invention; and

FIG. 6 is a cross-sectional view of the reflective mirror package taken along a line A-A illustrated in FIG. 5.

### DETAILED DESCRIPTION OF EXEMPLARY EMBODIMENTS OF THE INVENTION

Hereinafter, the present invention will be described in detail by explaining exemplary embodiments of the invention with reference to the attached drawings.

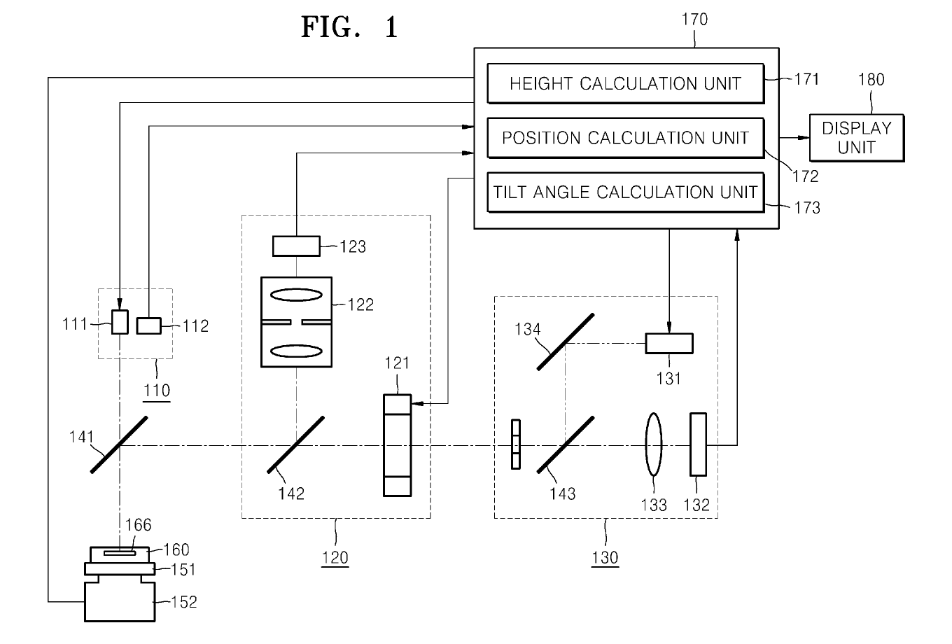

FIG. 1 is a structural view of an apparatus for measuring a 3D position and an orientation of an object according to an exemplary embodiment of the present invention.

Referring to FIG. 1, the apparatus includes a height measurement unit 110, a position measurement unit 120, a tilt angle measurement unit 130, a controlling unit 170, and a display unit 180.

An object 160, such as a reflective mirror package, is mounted on a stage 151. The stage 151 is moved accurately along six axes by a stage driving unit 152 disposed below the stage 151.

The height measurement unit 110, the position measurement unit 120, and the tilt angle measurement unit 130 constitute a coaxial optical system in conjunction with first through third semi transparent mirrors 141, 142 and 143. In this regard, when the object 160 is mounted on the stage 151, the height variation (δZ), the position variation (δX, δY, θ) and the tilt angles (α, β) of the object 160 can be simultaneously measured. Thus, the position of the object 160 does not have to be changed by moving the object 160 whenever each of the height variation (δZ), the position variation (δX, δY, θ) and the tilt angles (α, β) of the object 160 are checked. Thus, the apparatus for measuring a 3D position and an orientation using such simultaneous measurement method can reduce a period of time required for measuring the 3D position and the orientation of the object 160.

The height measurement unit 110 obtains information regarding the height of the object 160, and includes a first light source 111 and a first image sensor 112 receiving light reflected from the object 160 to form an image. The first light source 111 may include a red laser diode (LD) emitting light having a wavelength of 680 nm, and the first image sensor 112 may include a charge coupled device (CCD) camera.

Light emitted from the first light source 111 passes through the first semi transparent mirror 141 to be emitted to the object 160, and the light reflected from the object 160 is received by the first image sensor 112.

The first light source 111 and the first image sensor 112 are electrically connected to the controlling unit 170. Thus, the first light source 111 is powered on or off by the controlling unit 170, and the image formed by the first image sensor 112 is transferred to the controlling unit 170.

The first semi transparent mirror 141 is installed at a location where optical paths of light passing through the first light source 111 and the second semi transparent mirror 142 are perpendicular to each other. Accordingly, the light reflected from the object 160, which is selected from among the light emitted from the first light source 111, passes through the first semi transparent mirror 141 to be incident on the first image sensor 112.

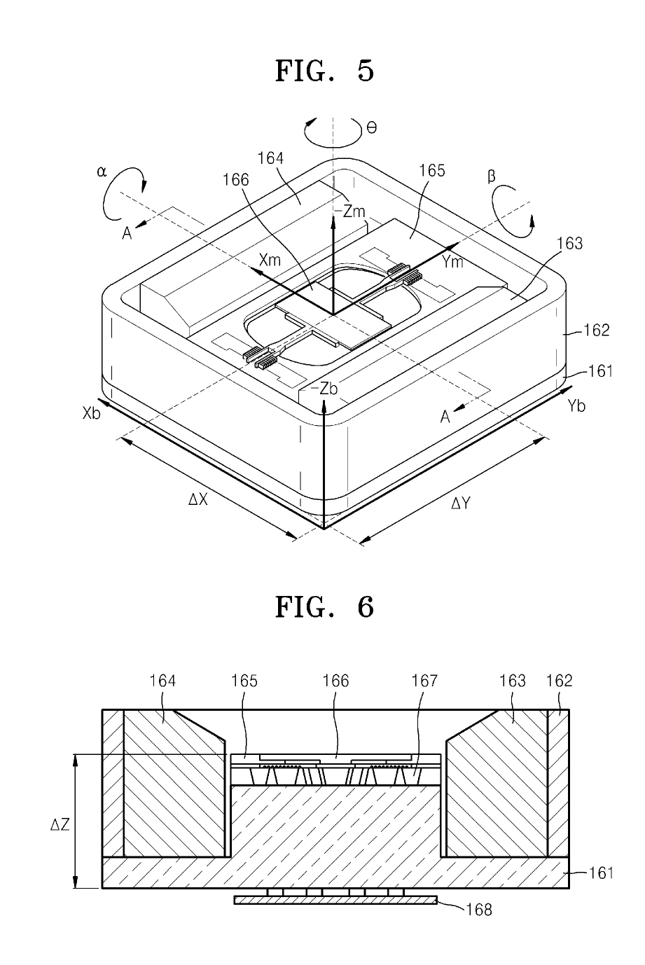

The position measurement unit 120 obtains information regarding the 2D variation (δX, δY) and the rotation angle (θ) of the object 160, and includes a second light source 121 emitting light, a telecentric lens 122, and a second image sensor 123. The second light source 121 may include a light emitting diode (LED) emitting white light, and the second image sensor 123 may include a CCD camera. The telecentric lens 122 is included in the position measurement unit 120 since beams forming images formed along a base line and a measurement surface need to have a confocal point in the second image sensor 123 in order to measure the 2D variation (δX, δY) and the rotation angle (θ) of the object 160. Also, parts of an image, which show minute gaps of the object 160, need to be clearly formed in order to improve the precision of the image. In this regard, the base line is an edge of an upper surface of a yoke 162 (see FIG. 5), and the measurement surface is a reflective mirror 166. Thus, the light reflected from the object 160 is reflected by a reflective surface of the object 160 in all directions. However, since the telecentric lens 122 focuses only light that is perpendicularly incident on the telecentric lens 122 on the second image sensor 123, the telecentric lens 122 can have the depth of focus for the height variation (δZ). Thus, an image having no aberration can be obtained even for the parts of the image that show minute gaps.

The second light source 121 and the second image sensor 123 are electrically connected to the controlling unit 170. Thus, the second light source 121 is powered on or off by the controlling unit 170, and an image formed by the second image sensor 123 is transferred to the controlling unit 170.

The second semi transparent mirror 142 is installed at a location where optical paths of light passing through the second light source 121 and the telecentric lens 122 are perpendicular to each other. Accordingly, the light emitted from the second light source 121 passes through the semi transparent mirror 142 and is directed to the object 160, and the light reflected from the object 160 is reflected by the second semi transparent mirror 142 to be incident on the telecentric lens 122.

The tilt angle measurement unit 130 obtains information regarding the tilt angle (α, β) of the object 160, and includes a third light source 131 and a third image sensor 132. The third light source 131 may include an LD emitting red light having a wavelength of 690 nm, and the third image sensor 132 may include a CCD camera.

A reflective plate 134 is installed in an optical axis passing through the third light source 131, and thus light emitted from the third light source 131 is reflected towards the third semi transparent mirror 143 disposed in an optical axis pasting through the third image sensor 132. An imaging optical system 133 is installed between the third semi transparent mirror 143 and the third image sensor 132. In addition, the imaging optical system 133 focuses the light emitted from the third light source 131 to be reflected from the object 160 on the third image sensor 132.

The third light source 131 and the third image sensor 132 are electrically connected to the controlling unit 170. Thus, the third light source 131 is powered on or off by the controlling unit 170. In addition, an image formed on the third image sensor 132 is transferred to the controlling unit 170.

The controlling unit 170 controls the first through third light sources 111, 121, and 131 to be powered on or off. In addition, the controlling unit 170 receives the images formed on the first through third image sensors 112, 123, and 132, and calculates the height variation (δZ), the 2D variation (δX, δY), the rotation angle (θ) and the tilt angles(α, β). To achieve this, the controlling unit 170 may include a height calculation unit 171 calculating the height variation (δZ), a position calculation unit 172 calculating the 2D variation (δX, δY) and the rotation angle (θ), and a tilt angle calculation unit 173 calculating the tilt angles (α, β).

The display unit 180 is used for displaying images and numerical values, which are measured or calculated by the controlling unit 170.

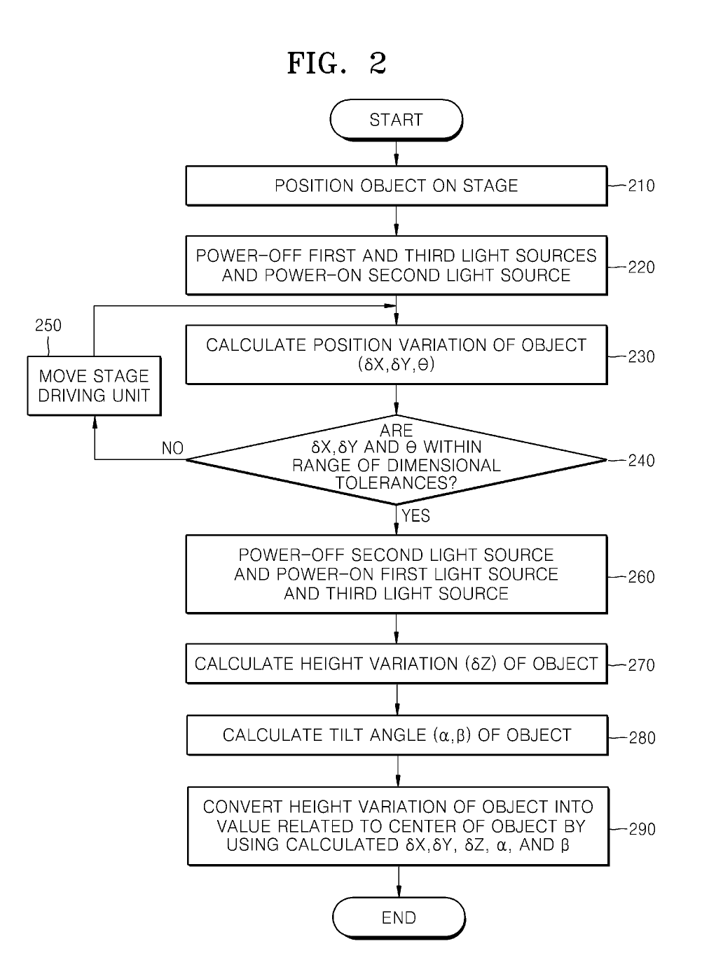

An operation of the apparatus for measuring a 3D position and an orientation of FIG. 1 will now be described with reference to the structural view of FIG. 1 and an operational flow chart of FIG. 2.

Various examples can be used as the object 160, but in the current exemplary embodiment, the object 160 is a reflective mirror package (hereinafter, referred to as the reflective mirror package 160).

Referring to FIGS. 5 and 6, the reflective mirror package 160 includes a base plate 161, a scanner die 165 which is installed on an upper surface of the base plate 161 and on which the reflective mirror 166 is installed, and the yoke 162 which is installed on the upper surface of the base plate 161 so as to surround the scanner die 165. Two magnets 163 and 164 are installed to face each other in the yoke 162. A coil 167 is disposed below the scanner die 165, and thus a Lorentz force is generated between the coil and the magnetic field generated by the magnets 163 and 164, thereby rotating the reflective mirror 166 by a desired degree. A printed circuit board (PCB) 168 is connected to a lower portion of the base plate 161. The magnets 163 and 164 and the base plate 161 are separated by predetermined gaps.

One vortex of the yoke 162 is the origin of a coordinate system (Xb, Yb, Zb), and the center of the first reflective mirror is the origin of a coordinate system (Xm, Ym, Zm). A distance between the origins of the two coordinate systems, which is measured along an X axis, is referred to as ΔX, a distance measured along a Y axis is referred to as ΔY, and a distance between an upper surface of the reflective mirror 166 and a lower surface of the base plate 161, which is measured along a Z axis, is referred to as ΔZ. In this case, distance variations of ΔX, ΔY and ΔZ can be referred to as δX, δY, and δZ.

The angles by which the reflective mirror 166 rotates around Zm, Xm, and Ym axes are referred to as θ, a tilt angle α, and a tilt angle β, respectively.

By measuring δX, δY, δZ, θ, α, and β of the reflective mirror package 160, the 3D position and the orientation of the reflective mirror package 160 can be measured. Then, it is checked whether δX, δY, δZ, θ, α, and β measured with respect to the reflective mirror package 160 are within the range of prescribed dimensional tolerances, and thus it can be determined whether the reflective mirror 166 is assembled at a desired position.

Since the above-described apparatus for measuring a 3D position and an orientation uses separate measurement image sensors, the apparatus for measuring a 3D position and an orientation can be easily used to measure various other objects. In addition, the apparatus for measuring a 3D position and an orientation can also be used for determining 3D positions and orientations of various precision parts having a surface similar to that of the reflective mirror package 160. In particular, the apparatus for measuring a 3D position and an orientation can be used for determining the intermediate assembling state and the final assembly state of the reflective mirror package 160. In addition, the apparatus for measuring a 3D position and an orientation can be used for determining 3D positions and orientations required for arranging CCD devices in a semiconductor process, can be used for measuring 3D positions and orientation of optical communication parts that need to be precisely arranged, and can be used for measuring 3D positions and orientations of precision parts used in a pickup of a compact disk (CD) player or a sound device.

Referring to FIG. 2, the object 160 is positioned on the stage 151 (operation 210).

Then, the 2D position (δX, δY, θ) of the object 160 is measured. The measurement is performed in operations 220 through 250.

The first light source 111 and the third light source 131 are powered off, and the second light source 121 is powered on (operation 220). Light emitted from the second light source 121 passes through the second semi transparent mirror 142, and then is reflected from first semi transparent mirror 141 towards the object 160. Light reflected from the object 160 is reflected by the first semi transparent mirror 141 and the second semi transparent mirror 142, and passes through the telecentric lens 122 to be received by the second image sensor 123, thereby forming an image of the object 160. δX, δY, and θ are measured with respect to the formed image (operation 230).

With regard to the measurement of δX, δY and θ, the position calculation unit 172 of the controlling unit 170 calculates δX, δY, and θ by using the image formed on the second image sensor 123.

In order to measure δX, δY, and θ, a base line Xb-Yb needs to be set with respect to an edge of the yoke 162. To achieve this, a horizontal square window (in the X axis direction) and a vertical square window (in the Y axis direction),are set according to the dimensional tolerances in the X and Y axis directions. In addition, two horizontal square windows (in the X axis direction) and two vertical square windows (in the Y axis direction), are set with respect to four edges of the reflective mirror 166, according to the dimensional tolerances in the X and Y axis directions.

Then, boundary lines between edges of the yoke 162 and the reflective mirror 166 are selected from the image formed on the second image sensor 123, wherein each of the brightness variations of the boundary lines are maximum, and then the boundary lines are each fitted into a straight line. Based on the fitted straight line, angles between a mean horizontal straight line or a mean vertical straight line and the straight line are calculated, and then the base line Xb-Yb is set, thereby calculating δX, δY, and θ. Since a method of calculating δX, δY, and θ is well known by one of ordinary skill in the art, the detailed description thereof will be omitted.

It is determined whether δX, δY, and θ that are measured in operation 230 are within the range of the dimensional tolerances (operation 240). If it is determined that δX, δY, and/or θ are not within the range of the dimensional tolerances, the stage driving unit 152 moves the stage 151 so as to change the position of the object 160 (operation 250). Then, operations before operation 230 are performed again.

When δX, δY, and θ that are measured in operation 230 are within the range of the dimensional tolerances, the second light source 121 is powered off, and the first light source 111 and the third light source 131 are simultaneously powered on (operation 260).

The height of the object 160 is measured based on light emitted from the first light source 111 (operation 270). The height of the object 160 is measured using optical triangulation performed by the height calculation unit 171 of the controlling unit 170. Light reflected from the reflective mirror 166 forms images at different locations of the first image sensor 112, according to the height variation of the object 160. A peak having maximum brightness is determined in the image formed by the reflected light that is scattered-reflected from the reflective mirror 166 on the first image sensor 112, and then the height variation of the object 160 can be obtained using optical triangulation. Since such optical triangulation is well known to one of ordinary skill in the art, a detailed description thereof will be omitted.

Then, the tilt angles (α, β) of the object 160 are measured based on light emitted from the third light source 131 (operation 280).

The tilt angle (α, β) are measured by the tilt angle calculation unit 173 of the controlling unit 170 that includes an autocollimator.

Due to the autocollimator, the light that is emitted from the third light source 131 to be reflected from the reflective mirror 166 is deflected by an angle twice the tilt angle (α, β) (the tilt angle here means two values!), and then is incident on the third image sensor 132. The variation of the tilt angles (α, β) of the reflective mirror 166 is expressed by the position variation of the third image sensor 132. The position variation is not related to the distance between the imaging optical system 133 and the reflective mirror 166, and is determined according to the coordinates and the focal distance (i.e., the distance between the imaging lens 133 and the third image sensor 132) of an image formed on the third image sensor 132. A method of measuring the tilt angles (α, β) by using the autocollimator is well known to one of ordinary skill in the art, and a detailed description thereof will be omitted.

Then, the height of the object 160, which was measured in operation 270, is converted into a value with respect to the center of the reflective mirror 166 by using δX, δY, α, and β which are measured in the above operations (operation 290).

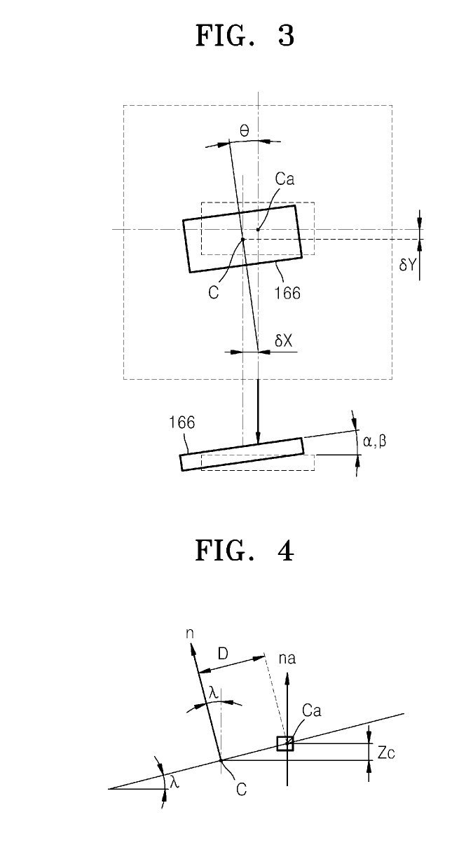

Referring to FIG. 3, when the reflective mirror 166 rotates by the rotation angle (θ), and is inclined by the tilt angles (α, β), the light emitted to the reflective mirror 166 in operation 270 is emitted to a location Ca that is eccentric with respect to the center C by a distance D, not with respect to the center C of the reflective mirror 166. Thus, in operation 270, a value that is actually measured with respect to the eccentric location Ca needs to be converted into a value with respect to the center C.

The eccentric distance D can be calculated according to the following equation 1.

D²=δX²+δγ² 1

In this case, δX and δY are values measured in operation 230.

A normal vector “n” of the reflective mirror 166, which is inclined by the tilt angles (α, β), is calculated according to the following equation 2.

n=(sin β, −sin α cos β, cos α cos β) 2

In this case, the height variation Zc=D sin λ, where λ=cos⁻¹(cos α cos β).

Zc calculated likewise is subtracted from the height variation of the object 160, which is calculated in operation 270, and thus the height variation of the object 160 can be converted into the value with respect to the center of the reflective mirror 166.

As described above, δX, δY, and θ of the 2D position of the reflective mirror 166, the height variation δZ, and the tilt degree (α, β) are sequentially calculated. However, a period of time required for intervals between the operations is only 0.1 second. Thus, since δX, δY, δZ, θ, α, and β are measured while operations 220 through 290 are performed within a very short period of time, it is considered that δX, δY, δZ, θ, α, and β are almost simultaneously measured. Thus, a period of time required for measuring δX, δY, δZ, θ, α, and β can be reduced. A pretty long period of time is required for arranging an object in a divisional measurement method. However, in such a simultaneous measurement method according to the above exemplary embodiments of the present invention, a checking time can be reduced due to automation of measurement, thereby reducing costs.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. An apparatus for measuring a three-dimensional position and an orientation of an object, the apparatus comprising:
a height measurement unit comprising a first light source and a first image sensor receiving light that is emitted from the first light source to the object and then is reflected from the object, the height measurement unit obtaining height information regarding a height of the object;
a position measurement unit which comprises a second light source and a second image sensor receiving light that is emitted from the second light source to the object and then is reflected from the object, the position measurement unit obtaining position information regarding a position of the object;
a tilt angle measurement unit which comprises a third light source and a third image sensor receiving light that is emitted from the third light source to the object and then is reflected from the object, the tilt angle measurement unit obtaining tilt angle information regarding a tilt angle of the object; and
a controlling unit which selectively powers on or off the first, second, and third light sensors, and calculates a height variation, a position variation and tilt angles of the object by using the height information obtained by the height measurement unit, the position information obtained by the position measurement unit, and the tilt angle information obtained by the tilt angle measurement unit,
wherein optical paths of light in the height measurement unit, the position measurement unit, and the tilt angle measurement unit are along the same optical axis, and the height measurement unit, the position measurement unit, and the tilt angle measurement unit operate independently.

2. The apparatus of claim 1, wherein the height information obtained by the height measurement unit comprises an image that is formed on the first image sensor, the position information obtained by the position measurement unit comprises an image that is formed on the second image sensor, the tilt angle information obtained by the tilt angle measurement unit comprises an image that is formed on the third image sensor.

3. The apparatus of claim 2, further comprising at least one semi transparent mirror which is disposed between the optical axis, allows light emitted from the first, second, and third light sources to proceed towards the object, and allows light reflected from the object to be received by the first, second, and third image sensors.

4. The apparatus of claim 2, wherein the position measurement unit comprises a telecentric lens.

5. The apparatus of claim 2, wherein the second light source is a light emitting diode.

6. The apparatus of claim 4, wherein the second light source is a light emitting diode.

7. The apparatus of claim 2, wherein the position, the height, and the tilt angles are sequentially calculated.

8. The apparatus of claim 2, further comprising a displaying unit which displays a result calculated by the controlling unit.

9. A method of measuring a three-dimensional position and an orientation of an object using an apparatus comprising a height measurement unit, a position measurement unit, a tilt angle measurement unit, and a controlling unit, wherein optical paths of light in the height measurement unit, the position measurement unit, and the tilt angle measurement unit are along the same optical axis, and the height measurement unit, the position measurement unit, and the tilt angle measurement unit operate independently, the method comprising:
positioning the object on a stage;
calculating, at the controlling unit, a position variation of the object by using position information obtained by the position measurement unit which comprises a second light source and a second image sensor receiving light that is emitted from the second light source to the object and then is reflected from the object;
calculating, at the controlling unit, a height variation of the object by using height information obtained by the height measurement unit which comprises a first light source and a first image sensor receiving light that is emitted from the first light source to the object and then is reflected from the object; and
calculating, at the controlling unit, tilt angles of the object by using tilt angle information obtained by the tilt angle measurement unit which comprises a third light source and a third image sensor receiving light that is emitted from the third light source to the object and then is reflected from the object.

10. The method of claim 9, wherein the height information obtained by the height measurement unit comprises an image that is formed on the first image sensor, the position information obtained by the position measurement unit comprises an image that is formed on the second image sensor, the tilt angle information obtained by the tilt angle measurement unit comprises an image that is formed on the third image sensor.

11. The method of claim 10, prior to the calculating of the position variation of the object, further comprising powering-off the first light source and the third light source and powering-on the second light source.

12. The method of claim 11, wherein the calculating the position variation of the object comprises:
calculating the position variation of the object by using the image formed on the second image sensor, wherein the calculating is performed by a position calculation unit of the controlling unit;
determining whether a position variation calculated by the position variation calculation unit is within a range of dimensional tolerances;
if it is determined that the position variation is not within the range of dimensional tolerances, changing the position of the object.

13. The method of claim 11, further comprising prior to the calculating the height variation of the object, powering-off the second light source, and powering-on the first light source and the third light source.

14. The method of claim 11, wherein the calculating the height variation of the object comprises optical triangulation.

15. The method of claim 11, further comprising after the calculating the tilt angles of the object:
calculating Zc that satisfies the following conditional expression by using the position variation (δX, δY), the tilt angles (α, β), and converting the height variation of the object into a value with respect to a center of the object by subtracting Zc from the height variation calculated in the calculating the height variation,
Zc=D sin λ,
where D²=δX²+δγ² and λ=cos⁻¹(cos α cos β).
